(19) United States
(12) Patent Application Publication
(10) Pub. No.: US 2017/0313509 A1
(43) Pub. Date: Nov. 2, 2017

(54) SENSORED TRASHCAN WITH CONTENT INDICATIVE LIGHT AND DECORATIVE MEMBERS

(71) Applicant: Jacqueline Mshamma, Lynchburg, VA (US)

(72) Inventor: Jacqueline Mshamma, Lynchburg, VA (US)

(21) Appl. No.: 15/141,184

(22) Filed: Apr. 28, 2016

(51) Int. Cl. B65F 1/14; F21V 33/00; B65F 1/16; B65F 1/06; G08B 5/36

(52) U.S. Cl. CPC B65F 1/1484; B65F 1/163; B65F 1/062; F21V 33/004; B65F 2210/129; B65F 2210/139; B65F 2210/168; G08B 5/36; B65F 2210/1443

(57) ABSTRACT

A trashcan configured with compartments and sensors in association with a lighting apparatus operable to make it easier to detect when the trashcan is full and the compartment makes it easier to reach the trash bags and change it conveniently, the trash bag compartment can be used to store waste bags such as waste from pets. The trashcan is an embodiments in accordance with the present invention to enable an interactive trashcan application and security system, method, and device for monitoring a trash controlled environment and for detecting an emergency condition in the controlled environment and generating a response based on the existence of the trash emergency condition.

### FIELD OF THE EMBODIMENT

Embodiments of the present invention generally relate to a system and method for area trash application, and particularly to a system and method for monitoring and security of trash application.

The aspect of the disclosed embodiment relate to a trashcan having many unique and useful features, including sensor devices, light, air freshener, compartment and outer layered surfaces, wherein the compartment can be decorated to personal liking, making this trashcan not like any other trashcan but rather a decorative item that is useful for applications such as kitchen, room or any environment where the trashcan is placed.

### BACKGROUND OF THE EMBODIMENT

Conventional trashcan is something that most people do not pay too much attention to because most conventional trashcans just provide a space for users of the trashcan to throw waste but there is usually nothing much one can do with such trashcan.

Disclosed embodiment takes all this to another level. Embodiment provide a trashcan that one can use as a decorative item placed in any part of the room. Certain embodiment provides a trashcan disposed with an outer-layered surface that can be personalized to one likes. Some embodiment provide the trashcan being disposed with either double layer with patterns of choice, stainless steel or with magnetic field decorative paper. Other embodiment provide the trashcan being affixed with a lighting apparatus. A sensor is associated with the lighting apparatus, wherein the sensor is operable to make it easier to detect when the trashcan is full and the compartment below makes it easier to reach the trash bags and change it conveniently. In the disclosure, the trash bag compartment can also be used to store waste bags such as waste from pets. One wouldn't have to hide our trashcan anymore because of this disclosed embodiment.

### SUMMARY

Embodiments in accordance with the present invention provide an interactive trashcan application and security system, method, and device for monitoring a trash controlled environment and for detecting an emergency condition in the controlled environment and generating a response based on the existence of the trash emergency condition.

Disclosed embodiment provide an innovative trashcan application, making it possible to customize trashcan use to one's liking. The trashcan can be used by people of all ages because of its convenience and safety. The light apparatus is configured to go off with different lighting colors representing the trashcan is empty, partially full or completely full. Disclosed embodiment will make it easier for adults and young people to detect and change the trash bag as needed. The sensor device can be used to cause the light to go On/Off in different colors depending on how full the trashcan is. Optionally, one can choose to have a sensor to open the trashcan lid; the sensor will not be limited to one function. The compartment being provided is used to store trash bags, making it easier to allocate the bags to enable quicker/easier change. Certain embodiment provide the air freshener being connected to a pressure device that is connected to the pedal. The pedal is configured to spray the freshener when stepped on it. A trashcan can be placed anywhere in the house and used to decorate the room; one can personalize the trashcan which makes it different from any other trashcan, this Is a decorative item like how one would use a picture frame to decorate the living room, one can use this trashcan to decorate the kitchen environment.

### DETAILED DESCRIPTION OF THE DRAWINGS

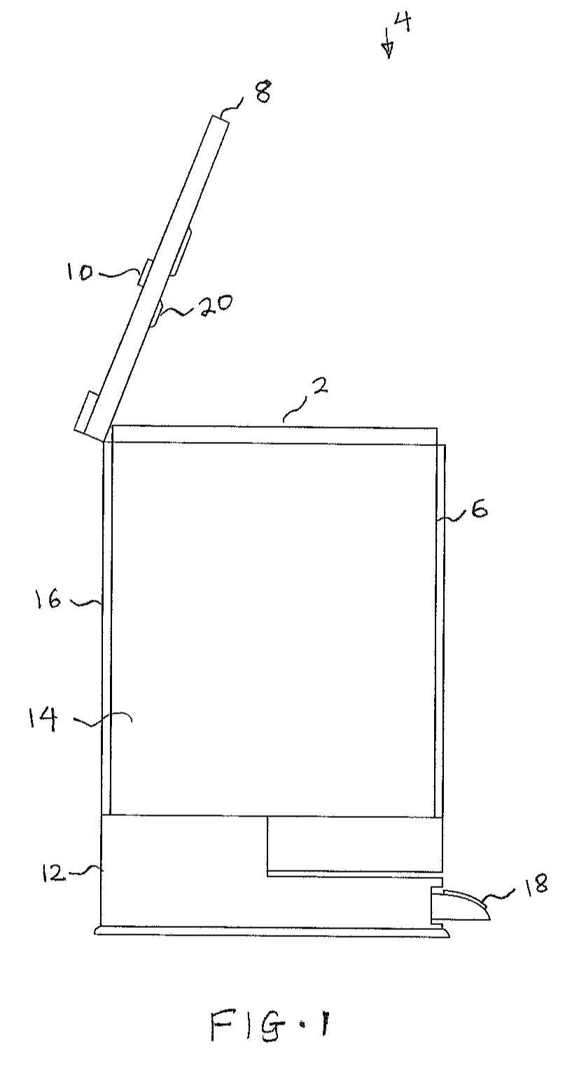

FIG. 1. Is an exemplary illustration of the front view of the trashcan.

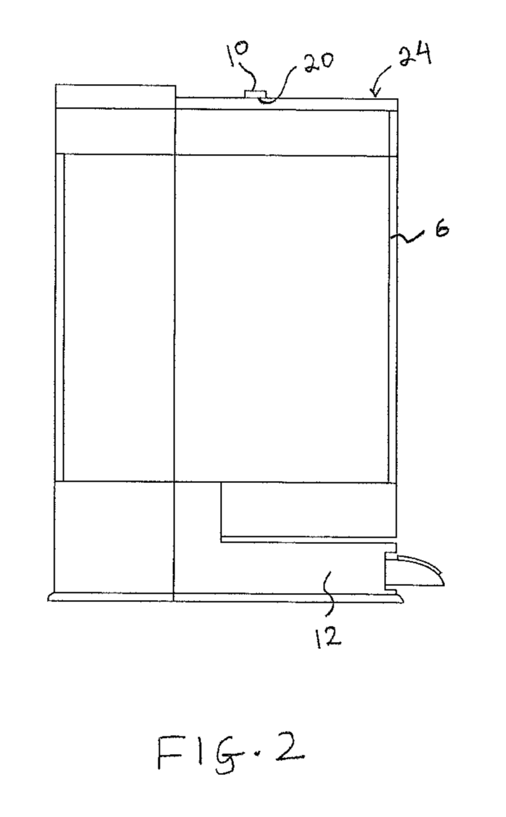

FIG. 2. Is an exemplary illustration of a side view of the trashcan.

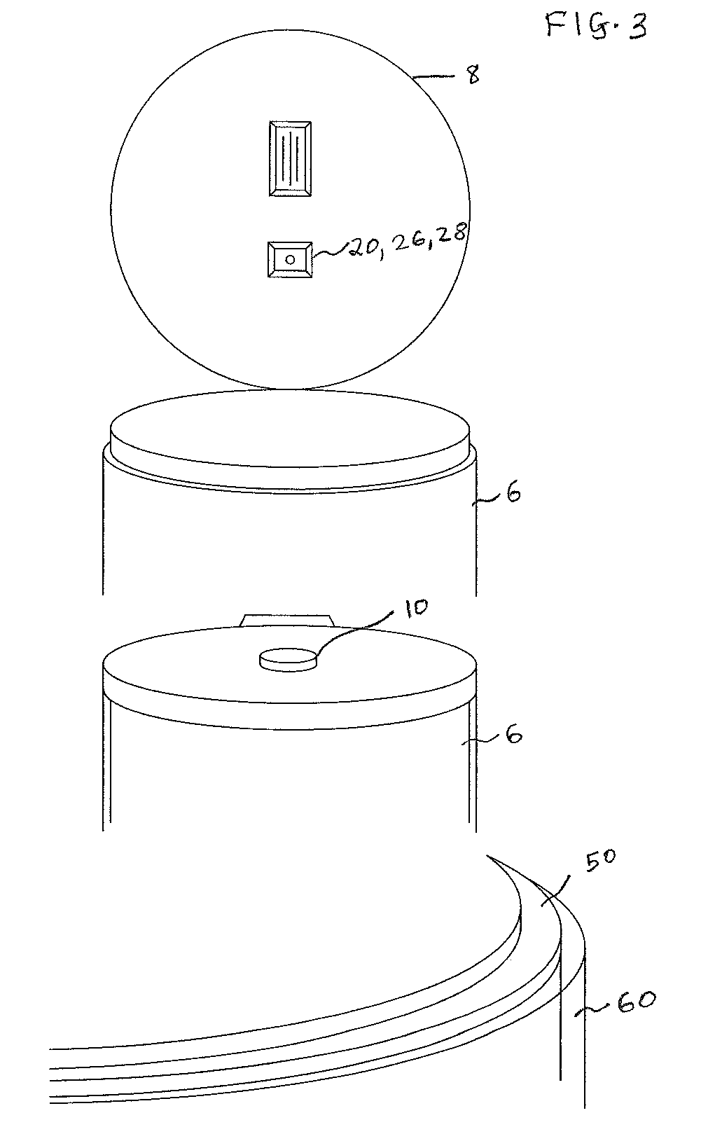

FIG. 3. Is an exemplary presentation of the top view of the trashcan, showing the inner part of the lid and the middle part or the main body of the trashcan

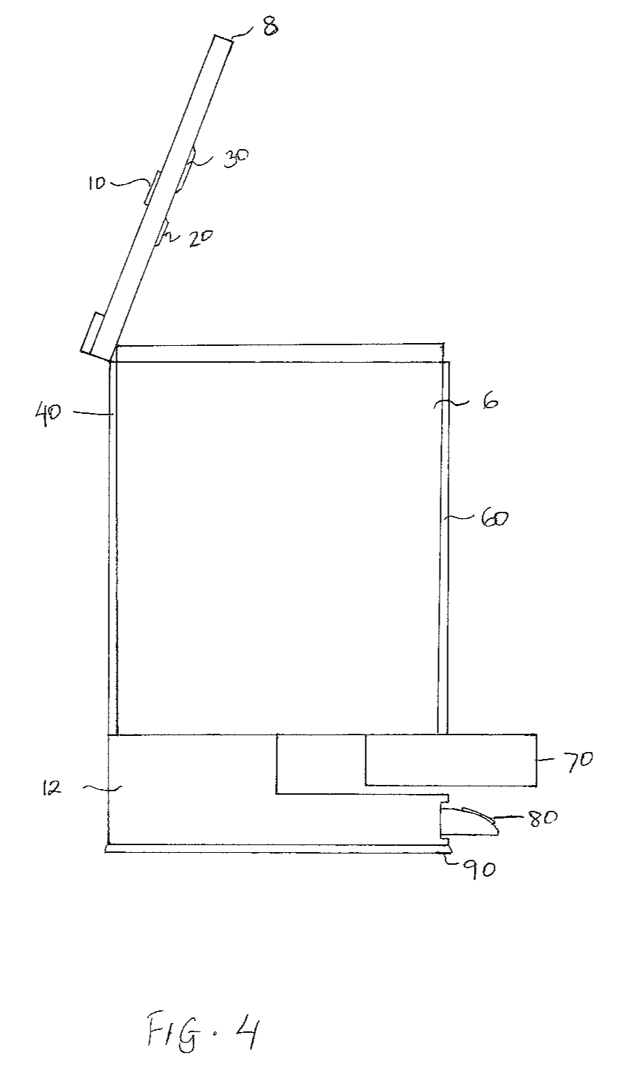

FIG. 4. Is an exemplary presentation of the bottom part of the trashcan, showing the compartments, pedal and the bottom lip.

The headings used herein are for organizational purposes only and are not meant to be used to limit the scope of the description or the claims. As used throughout this application, the words trashcan, sensors, lighting apparatus, container, lid, light, are used in permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise

### DETAIL DESCRIPTION OF THE EMBODIMENT

Figure I provide a trash storage system 2, comprises a container 4, usable to create a configurable and reconfigurable system. Each container 4 is associated with at least a trashcan 6 being disposed with at least a lid 8. The lid 8 is disposed with at least a light apparatus 10, in association with a sensor device 20. The container 4 is further configured with a storable base 12 that supports a body 14, and the lid 8 is located at the top of the body 14. The base 12 may be provided in a different configuration such that the system may be configured to meet the user's space, floor plan needs, and processes. In one embodiment the sizes of the base is related such that the base may be operable to create a unified system that activates the top lid 8. The container 4 is disposed with a releasable member 16, communicatively connected the pedal 18. The pedal 18 comprises application mechanism configured for activations that may include magnets, compartments, sensors, lights, decorative members.

Referring to FIG. 2, embodiment provide a trashcan 6, comprising a trash storage container having a base member 22 where the base has a depth and a width each comprising a suitable dimension to define a storable portion 24 to form a home trashcan application in connection with the sensor device 20 and light apparatus 10 to gain increased content level visibility and popularity. Within a home, multiple trashcan can be connected together in the home and/or used for office device applications to permit a user to be aware of trash security content level and other associated data content without having to manually inspect the trashcan 6. The trashcan 6 may be networked in connection with the sensor device 20 to permit the user to receive detected content level data or perform other distant environmental applications such as the sensor device 20 having connectivity with Internet access to facilitate responses to trash pickups. Thus, one can be informed of the trashcan reaching its maximum fillable capacity through a cell phone in communication with the sensor device 20. The sensor device further allows one to gain instant access to trash information source from anywhere.

Referring to FIG. 3 is further shown the illustrative embodiment of the invention. The present invention provides an interactive trash security system for monitoring a controlled trashcan environment and for detecting an emergency condition in the controlled environment and generating a signal indication based on the level of the emergency condition. Disclosed embodiment provides interactive trash security system comprising the trashcan 6 having lid 8 as seen on the top view illustration. The lid 8 is further disposed with light 10 being configured with multiple illuminating colors each indicative of trash level within the trashcan 6. Each color represents either the trashcan is empty, partially or completely full. The light apparatus 10 is connected to sensor device 20. Embodiment provide the sensor device 20 further comprises at least a proximity sensor 26, a radio frequency identifier device RFID 28, which senses the trash in the can and cause the activation of light apparatus 10 to indicate the colors.

Sensor device 20 can also be used to sense hand movement to automatically open up the lid 8. The application of the sensor device 20 is not limited to just operating the light apparatus 10, it senses odor and refreshes the trashcan 6 by pouring air freshener 30 to eliminate the odor. The air freshener is connected to pressure device 40 that is connected to the pedal 80. In this regards, when one presses on the pedal 80, the pressure device 40 causes the air freshener 30 to spray the freshener as the lid opens. The pressure device 40 further comprises an actuator for the air freshener. In other embodiment, if the outer layered surface 60 is disposed as a double layered surface, then the ring covering the outer layer 50 protects the decorative paper. The layers 60, which is the main body, can also be stainless steel configured with magnetic field depending on design choice. The decorative paper can be changed depending on the theme of the kitchen or where it is placed or holiday seasons.

Referring to FIG. 4, the sensor device 20 governs communications or detection of a system component to the trashcan 6. In an embodiment, the sensor device 20 generates an environment profile to track and monitor contents and levels and applications within the container. The trashcan 6 is graphic based or graphical interface enables a user to specify the location, the decoration, or dimensions of the container for monitoring and may include a home, an office, an educational institution, a medical institution, an industrial establishment, or a residential building where monitoring and security of home is desired. The bottom part of the trashcan 6 is the base 12, which is below layer 60. The compartment 70 can further be used to store in trash bags or any other items that may be needed. Embodiment provides the compartment 70 further comprises an easily accessible waste bags for pets and other applications. Some embodiment provide the pedal 80 in association with the pressure device, such that when stepped on connects to pressure device 40 to activate the air freshener 30, and at the same time opens the lid 8 and causes the air freshener 30 to be released into the trash environment. The bottom lip 90 is used as a strong base to place the trashcan in place.

While certain aspects and embodiments of the disclosure have been described, these have been presented by way of example only, and are not intended to limit the scope of the disclosure. Indeed, the novel of the apparatus described herein may be embodied in a variety of other forms without departing from the spirit thereof. The accompanying claims and their equivalents are intended to cover such forms or modifications as would fall within the scope and spirit of the disclosure. It is to be understood that the scope of the present invention is not limited to the above description, but encompasses the following claims;

What is claimed:

1. An interactive trashcan security system for detection, the system comprising: at least a container comprising a trashcan; at least a sensor positioned at one or more predetermined locations of said trashcan, wherein the sensors are associated with a sensor to collect trash level data; and at least one indicator apparatus in association with said sensor responsive to content level condition; and said container further disposed with at least a lid, a compartment, and at least a decorative material.

2. The system of claim 1, further comprising a control configured to provide one or more air freshener to said container.

3. The system of claim 1, wherein said container further comprising a covering unit in association with said pressure device configured to activate the air freshener.

4. The system of claim 1, wherein said pressure device in communication with said sensor device.

5. The system of claim 4, further comprising a communication system for trash monitoring applications.

6. The system claim 1, wherein said container comprises a trashcan being disposed with at least a light apparatus.

7. The system of claim 1, wherein said sensor device further responsive to environmental emergency condition.

8. The system of claim 1, wherein said container further disposed with at least a base in association with said pressure device.

9. The system of claim 1, wherein said pressure device further comprises a pressure sensing device.

10. The system of claim 1, wherein said light apparatus further comprises an environmental illuminance device.

11. The system of claim 1, wherein said light apparatus further comprises a content responsive indicator.

12. The system of claim 1, wherein the sensor device comprises a plurality of sensors positioned at one or more predetermined locations of said container.

13. The system of claim 1, wherein the sensor further configured to detect trash level and to detect trash emergency condition within the controlled environment

14. The system of claim 1, wherein said pressure device further comprises a dual pressure system configured for multiple applications.

15. The system of claim 14, wherein at least one application activates the lid of said container.

16. The system of claim 14, wherein at least one application activates an air freshener.

17. The method of claim 10, wherein generating the alarm comprises displaying sensor data on a media device.

18. The system of claim 1, wherein said container further disposed with at least a compartment for storing trash bags.

19. The system of claim 1, wherein said container further disposed with changeable decorative materials.

20. The system of claim 19, wherein said container for disposed with apparatus for enabling network communications.
